(19) United States
(12) Patent Application Publication
(10) Pub. No.: US 2010/0112223 A1
(43) Pub. Date: May 6, 2010

(54) PRINTING SUPERIMPOSED LAYERS

(75) Inventor: George Roland Hill, Cheshire (GB)

Correspondence Address: PILLSBURY WINTHROP SHAW PITTMAN, LLP, P.O. BOX 10500, MCLEAN, VA, 22102, US

(73) Assignee: CONTRA VISION LTD., Cheshire (GB)

(21) Appl. No.: 12/514,714

(22) PCT Filed: Nov. 14, 2007
(86) PCT No.: PCT/IB07/04462

§ 371 Date: Jan. 12, 2010

Related U.S. Application Data
(60) Provisional application No. 60/858,697, filed on Nov. 14, 2006.

(51) Int. Cl. B05D 1/32; B32B 3/10; B41M 3/00; B44C 3/00

(52) U.S. Cl. 427/259; 428/201

(57) ABSTRACT

An apparatus and method for making a panel with superimposed layers of marking material in substantially exact registration is provided. An assembly includes a stencil layer sandwiched between a substrate and a transparent coating. The stencil includes a release surface. The coating tends to secure the stencil layer to the substrate, e.g., for storage and/or transport, and may protect the stencil layer from marking materials that might otherwise penetrate the stencil layer. A design and background layers are then printed onto the coating. A force is then applied to remove the background layer, design layer, and coating that are disposed on the stencil layer, leaving the remainder of the background layer, design layer, and coating adhered to the substrate in substantially exact registration within portions of the substrate that are devoid of the stencil layer. The design layer is right-reading visible through the substrates.

### CROSS-REFERENCE

This application claims the benefit of priority to U.S. Provisional Patent Application No. 60/858,697, titled “Improvements to Printing Superimposed Layers,” filed on Nov. 14, 2006, which is incorporated herein by reference.

### BACKGROUND OF THE INVENTION

1. Field of the Invention

The present invention relates generally to products and methods of partially printing products comprising superimposed layers of marking material in substantially exact registration.

2. Description of Related Art

GB 2 118 096, US RE37,186, U.S. Pat. No. 4,925,705, U.S. Pat. No. 6,267,052, U.S. Pat. No. 6,899,775, U.S. Pat. No. 6,824,639, PCT/GB2003/004216 and PCT/IB2007/002324 disclose methods of partially printing substrates with superimposed layers of ink or other marking material in substantially exact registration. One of the disclosed methods in GB 2 118 096, US RE37,186, U.S. Pat. No. 4,925,705 and PCT/IB2007/002324 is the application of a stencil or mask to parts of a substrate, followed by a plurality of layers of marking material, followed by removal of the plurality of layers of marking material over the parts of the substrate covered by the stencil and optionally the stencil itself, to leave the layers of marking material remaining on the substrate in substantially exact registration. Such methods have been used in the manufacture of vision control panels, for example according to US RE37,186, which discloses the use of a “part processed substrate”, comprising a pre-printed stencil layer and typically layers of black and white ink for subsequent conversion into a finished product by the printing of a design and removal of unwanted ink. Patent Application PCT/IB2007/002324 discloses metallisation as a layer of marking material in such a method, for example disposed between a black layer and a white layer of a vision control panel, for example as a one-way vision panel according to US RE37,186. The metallised layer is disclosed to perform a number of possible functions within such products and methods of making such products. When located intermediate black and white layers, a silver colored metallised layer assists the creation of a relatively bright white surface on which to superimpose and act as a suitable white background to design color layers, for example four color process colors of cyan (C), magenta (M), yellow (Y) and process black (K). Also disclosed is the potential of the metallised layer to act as a barrier to solvents, for example from design color inks, from attacking the stencil layer, which may be vulnerable to such solvents, as might underlying layers of the substrate and/or any adhesive on the other side of the substrate, for example in a self-adhesive film assembly. However, such metallisation, for example of aluminium, typically comprises a very thin layer and is only partially effective in acting as a barrier layer to certain solvents commonly used in digital inkjet printing inks. Also, for vision control panels to be applied to the inside of a window and other products in which a design is reverse printed on one side of a transparent substrate, to be visible through the substrate from the other side of the substrate, a metallised layer between the stencil material and the design color layer or layers would obscure or partially obscure visibility of the design, depending on the thickness of metallic deposition.

Prior art stencil materials, for example as disclosed in US RE37,186, are printable but do not adhere strongly to the substrate, being required to be easily removed. They are also typically friable, easily damaged by even light abrasion.

### SUMMARY OF THE INVENTION

One or more embodiments of the present invention provide a method of printing vision control panels and other partially printed products.

One or more embodiments of the present invention provide an assembly that includes a substantially imperforate substrate, a transparent coating, and a stencil layer. The stencil layer includes a release surface disposed between the substrate and the coating. A cross-section through the assembly includes the substrate having two outer edges, the coating having two outer edges, and a plurality of alternate stencil layer portions and portions devoid of the stencil layer. Each stencil layer portion has two outer edges. The coating is located on the surface of the stencil layer remote from the substrate and is firmly adhered to the substrate within each of the plurality of portions devoid of the stencil layer.

According to a further aspect of one or more of these embodiments, the substrate is transparent, optically transparent, or translucent.

According to a further aspect of one or more of these embodiments, the assembly includes a design layer printed reverse-reading onto the assembly on a side of the coating remote from the substrate, the design layer being right-reading visible through the substrate. A background layer may be printed over the design layer.

According various of these embodiments, the assembly is rolled into a roll or is cut into a sheet.

According to a further aspect of one or more of these embodiments, the coating is continuous and bridges each boundary between the stencil layer and the substrate disposed within the plurality of portions devoid of the stencil layer.

According to various of these embodiments, the release surface is disposed on a substrate side of the stencil layer and/or on a coating side of the stencil layer.

According to a further aspect of one or more of these embodiments, the coating includes two layers, a first layer of which adheres the stencil layer to the substrate, a second layer of which provides a print-receptive surface. The second layer is disposed on a side of the first layer remote from the substrate. The first and second layers are different materials.

According to a further aspect of one or more of these embodiments, the coating further includes a third layer that is substantially impervious to solvent-based inks, the third layer being disposed on the side of the first layer remote from the substrate. The third layer is a material that is different than the first and second layers of the coating.

According various of these embodiments, the stencil may be transparent, optically transparent, water clear, or translucent.

Another embodiment of the present invention provides a method of making a design on an assembly according to one or more of the above-described embodiments. The method includes printing a plurality of layers of marking material onto the assembly on a side of the coating remote from the substrate. The plurality of layers include a design layer and a background color layer. The design layer is applied reverse-reading and is right-reading visible through the substrate.

Another embodiment of the present invention provides a method of making a design on an assembly according to one or more of the above-described embodiments. The method includes printing a plurality of layers of marking material onto the assembly on a side of the coating remote from the substrate, the plurality of layers comprising a design layer and a background color layer, the design layer being disposed between the background color layer and the substrate, the design layer being visible through the substrate.

According to a further aspect of one or more of these the above embodiments, the method also includes, prior to printing the plurality of layers of marking material onto the assembly, transporting the assembly from a first geographic location to second geographic location disposed at least a mile away from the first geographic location.

According to a further aspect of one or more of these embodiments, the method also includes, prior to transporting the assembly from the first geographic location to the second geographic location, rolling the assembly into a roll. The method may further includes, before printing the plurality of layers of marking material onto the assembly, unrolling the rolled assembly.

According to a further aspect of one or more of these embodiments, the assembly is rolled into a roll, and the method further includes unrolling the assembly prior to printing the plurality of layers of marking material onto the assembly.

According to a further aspect of one or more of these embodiments, the method further includes applying a force to the plurality of layers of marking material. The force substantially removes the coating and the plurality of layers of marking material disposed on the stencil layer, while leaving the coating and the plurality of layers of marking material adhered to the substrate in substantially exact registration within the edges of the plurality of portions devoid of the stencil layer.

According to a further aspect of one or more of these embodiments, the plurality of layers of marking material include marking materials that would penetrate the stencil layer if printed directly onto the stencil layer.

According to another embodiment of the invention, an assembly comprises a substantially imperforate substrate, a partially adhered transparent coating and a stencil layer, said stencil layer being in a stencil pattern, said stencil layer comprising a release surface, said stencil pattern being the negative of and thus defining a print pattern, wherein a cross-section through said assembly comprises said substrate having two outer edges, said partially adhered transparent coating having two outer edges and a plurality of alternate stencil layer portions and portions devoid of the stencil layer, each stencil layer portion having two outer edges, said partially adhered transparent coating being located on the surface of said stencil layer remote from said substrate and being firmly adhered to said substrate within each of said plurality of portions devoid of said stencil layer, said assembly being capable of conversion to a panel comprising a plurality of layers of marking material within said print pattern having edges of said layers of marking material in substantially exact registration.

One or more of the above-described embodiments may be capable of being converted to a panel which comprises a substantially imperforate substrate, a print pattern comprising a transparent coating and a plurality of layers of marking material superimposed in substantially exact registration, said print pattern subdividing the panel into a plurality of discrete areas of said marking material and/or a plurality of discrete areas devoid of said marking material, wherein a cross-section through said panel comprises said substrate having two outer edges and a plurality of alternate printed portions and unprinted portions, each of said printed portions having two outer edges, one of said printed portions comprising a part of said transparent coating having two outer edges, a part of a layer of said marking material having two outer edges and a part of another layer of said marking material having two outer edges, and wherein within said one of said printed portions one of said two outer edges of said part of said transparent coating and one of said two outer edges of said part of a layer of said marking material and one of said two outer edges of said part another layer of said marking material are substantially aligned.

Also according to one or more of these embodiments, there is a method of making an assembly comprising the steps of:
(i) applying said stencil layer in said stencil pattern to said substrate, said stencil pattern subdividing said substrate into a plurality of discrete areas of said stencil layer and/or a plurality of discrete areas devoid of said stencil layer, and
(ii) applying said partially adhered transparent coating over said substrate and said stencil pattern, said partially adhered transparent coating being firmly adhered to said substrate where said substrate is devoid of said stencil layer.

One or more of the above-described assemblies may be convertible to a panel by a method further comprising the steps of:
(i) applying a plurality of layers of marking material to said partially adhered transparent coating, and
(ii) applying a force to the exposed surface of said plurality of layers of marking material, said force substantially removing said partially adhered coating and said marking material from on said stencil layer, leaving said transparent coating and said plurality of layers of marking material in substantially exact registration within the edges of said print pattern.

The following definitions apply herein.

A “substrate” is a single sheet of homogeneous material or a multi-layer material, for example incorporating the overall application of a print-receptive coating or a printed ink layer. The substrate is imperforate except, for example, for any holes that may be used to assist printing registration or to feed the substrate through a printing or other machine. The substrate can be of any material, including opaque, translucent, transparent, or optically transparent materials, for example plastics, glass, metal, wood, paper and composite materials.

A “transparent material” is a water clear or tinted material that allows an image applied to one side of the transparent material to be visible through the transparent material from the other side of the transparent material. Examples of transparent materials include glass, plastic films including pvc, polyester, polyethelene, polypropylene and polycarbonate films, rigid or semi-rigid plastic sheets, for example including acetate, acrylic, polycarbonate and pvc sheets.

An “optically transparent material” is a water clear or tinted material that allows an observer to see through the material and focus clearly on an object spaced from the other side of the panel. Examples of optically transparent materials include glass, plastic films including pvc, polyester, polyethelene, polypropylene and polycarbonate films, rigid or semi-rigid plastic sheets, for example including acetate, acrylic, polycarbonate and pvc sheets, having two substantially parallel, plane surfaces.

The “print pattern” comprises a plurality of printed layers, the printed layers subdividing the panel into a plurality of discrete printed areas and/or a plurality of discrete areas devoid of the printed layers. Examples of print patterns include a pattern of dots or lines or a grid, net or filigree pattern. The print pattern may be a regular or irregular pattern.

A “stencil pattern” is the negative of the print pattern, and subdivides the assembly into a plurality of discrete areas of stencil material and/or a plurality of areas devoid of stencil material.

A “design” is the visible image of one or more “design layers” typically seen superimposed in front of a background color layer.

A “design layer” comprises at least one “design color layer” and can be a single layer of a single material, such as a single design color layer of ink, or a multi-color process layer, in which the individual design color layer deposits, for example cyan, magenta, yellow and process black, are typically discontinuous within the design layer.

In this first embodiment of the invention, the assembly is typically intended to be converted into a panel partially covered with layers of marking material which are coterminous at one or more edges, in substantially exact registration. A stencil is formed on the substrate, for example by printing a stencil layer. The substrate and the stencil layer are covered with a “partially adhered transparent coating” (sometimes abbreviated herein as the “PAT coating”) which is adhered to the substrate outside the area or areas of the stencil pattern. However, the release surface of the stencil prevents the coating from having a strong bond to the substrate throughout the area or areas of the stencil pattern and the coating is thus referred to herein as being partially adhered or differentially adhered to the substrate. The partially adhered transparent coating is complex in the sense of having multi-purpose or multi-functional characteristics.

Conversion of the assembly to form a finished panel typically comprises the application of a plurality of layers of marking material onto the PAT coating, over part or all of the stencil layer and exposed substrate surfaces, and the subsequent selective removal of parts of the plurality of layers of marking material and partially adhered transparent coating outside the area or areas of the print pattern and, optionally, the removal of the stencil layer, leaving the remaining layers of marking material in substantially exact registration, being substantially coterminous at one or more edges.

In this first embodiment of the invention, the multi-purpose “partially adhered transparent coating” typically:
(i) retains a stencil layer on the substrate, and
(ii) protects the stencil from abrasion, and
(iii) provides a receptive coating to the subsequent application of marking material, and
(iv) provides a barrier layer to protect the stencil from deleterious matter, in (a) the handling, packaging and transporting of the assembly, and (b) the subsequent application of layers of marking material, for example solvent inks, and
(v) in the case of a stencil layer comprising a release surface remote from the substrate, it avoids the difficulty and/or undesirable effects of marking material being applied to a release surface, for example affecting curing or causing overall image contamination by translation of ink deposits from the release surface to within the print pattern.

The partially adhered transparent coating optionally comprises a single layer or a plurality of layers of the same material, in order to build up the required coating thickness and/or a plurality of different materials performing different functions.

The partially adhered transparent coating therefore typically provides an imaging surface and separates, spaces and protects the stencil release surface from the imaging surface. The stencil layer is optionally:
(i) applied to the substrate, for example is printed onto the surface of the substrate, or
(ii) is formed as an integral part of the substrate, for example in a co-extrusion process, and/or
(iii) is optionally formed by ablation of an applied layer or integral layer within a substrate.

The stencil layer has a release surface which is optionally:
(a) adjacent to the substrate, or
(b) remote from the substrate.
   These two types of stencil may be referred to as:
a “substrate release stencil”, or
a “remote release stencil”.

For example, a Lexan® polycarbonate film comprises a Marguard® scratch resistant, low energy surface and the area or areas outside the stencil pattern are ablated, for example laser etched, to leave the parent substrate material exposed in the area of the print pattern (Lexan® and Marguard® being trademarks of GE Plastics, USA). In this case, the stencil layer comprises the remaining scratch resistant coating and the scratch resistant surface comprises the release surface. “Scratch resistant” is a relative term and such surfaces are still subject to scratching and contamination and a partially adhered transparent coating over the scratch resistant surface typically provides a variety of protective functions as well as, optionally, superior image receptive properties to the substrate parent material.

A substrate release stencil typically has sufficient bond to the applied layers of marking material to be removed along with the layers of marking material on the stencil. Optionally, a substrate release stencil is removed in a separate stencil removal process.

A remote release stencil is not removed in the process of removing the superimposed layers of marking material above the stencil and is either
(i) retained as part of the finished product, or
(ii) is removed in a separate stencil removal process.

In the case of a remote release stencil, the partially applied transparent coating acts as a barrier layer protecting the stencil release surface, typically rejecting or absorbing any deleterious matter encountered in the normal process of material handling, packaging and transport or deleterious matter in the marking material layers themselves, for example solvents in liquid inks which may attack and affect the functional performance of the stencil layer.

The partially adhered transparent coating also provides an important physical separation function of the marking material from the release surface. Release surfaces are typically of low surface energy, not receptive to conventional marking materials. For example, solvent inkjet ink will typically not spread or adhere to such surfaces but will coalesce into ink globules which are not adhered to the release surface and are liable to translate (or move sideways) and contaminate ink deposits within the print pattern. UV curing inks will typically cure on a release surface but, for example, the discrete cyan, magenta, yellow and process black deposits of a UV inkjet machine may not adhere to the release surface but are liable to “skate” along the surface and contaminate subsequently printed layers within the print pattern or contaminate the printing machine, affecting subsequent printing processes. The partially adhered transparent coating is preferably receptive to the subsequently applied layers of marking material and different coatings are typically desirable for different types of imaging system. If the substrate is transparent, the partially adhered transparent coating is also typically required to be transparent, in order for an observer to see a desired color rendering or perceived color through the substrate, for example in a see-through graphic panel, for example according to US RE37,186. The stencil material is preferably water clear because if it is colored there is a danger of the colorant migrating to the substrate.

A substrate release stencil is typically very vulnerable to damage, including local removal by even very light abrasive forces, for example hand brushing, as the primary function of the stencil layer is not to have substantial bond to the substrate and be capable of easy removal along with the unwanted layers of marking material above it. A primary function of the partially adhered transparent coating is to retain the stencil layer on the surface of the substrate in the required area or areas under a range of specified or unspecified loading conditions. For example, if an assembly is a “Part Processed Material” for conversion by printers, it should preferably withstand the surface frictional forces imposed by handling sheets, typically including the stacking of Part Processed Material sheets, or the frictional forces imposed by rolling and unrolling Part Processed Material in roll form. The assembly should be able to remain serviceable without significant damage during the guillotine cutting of sheets or the slitting of rolls to the size desired by the printer, subsequent packaging including any banding and palleting, the impact and vibration of handling at the warehouse, delivery, unpacking, stocking in sheet or roll form, handling to and through the imaging system, for example a printing machine, any anti-static or other substrate cleaning process, for example a cleaning and anti-static roller treatment unit on the feed end of a screen printing machine to remove dust and reduce the attraction of dust to the Part Processed Material in the printing process.

The stencil layer can be printed on a roll of film substrate by any web printing process, for example gravure, flexo or rotary screen printing. Preferably the stencil is applied by a “deep etch” gravure cylinder or roller and the partially adhered transparent coating is applied with an annilox cylinder roller, which applies an array of closely spaced liquid deposits of the coating, which spread to form a substantially uniform layer.

The partially adhered transparent coating retains the stencil layer to the substrate by means of adhesion throughout the area or areas of the print pattern and being able to withstand the service stresses imposed prior to imaging. However this function, which could be described as “tacking” the stencil to the substrate, is not easy to achieve. If the function was limited to one of retention then the partially adhered transparent coating would preferably have substantial tensile strength, sometimes referred to as “ membrane” or “in plane” tensile strength, to hold down the stencil layer, for example by means of a thick UV-cured coating with the substantial tensile strength achieved by the characteristic “chemical cross-linking” of UV-cured materials. However, such a thick UV-cured coating would typically render impossible the subsequent “ink fracture mechanism” around the edges or boundaries of the stencil layer required to remove the stencil layer and the superimposed layers of marking material above the stencil layer. The partially adhered transparent coating preferably therefore has sufficient tensile strength to resist ink fracture and removal of the stencil under service loading but positively enable ink fracture and removal of unwanted material following the application of the plurality of layers of marking material, for example by the application and removal of an adhering surface, for example a plastisol ink or a self-adhesive film, or jetting, for example by water jetting or air jetting, with or without an abrading medium.

Another potentially vital function of the partially adhered transparent coating is to prevent or ameliorate solvent attack on the stencil layer, for example which can result in “pinholes” or larger holes within the stencil layer, which would otherwise result in marking material being adhered to the substrate within the area or areas of the stencil pattern, which should not be imaged in the finished panel, for example in areas required to be transparent within a vision control panel. The partially adhered transparent coating is at least partially resistant to solvent attack and solvent permeability. Transparent ink lacquers and varnishes are typically less permeable than pigmented, colored inks, including white and black inks, as they predominantly comprise a binder with additives, for example to assist ink flow. For example, a transparent coating comprising Coates Vynaglaze™ overprint varnish 4795, which is otherwise used for different prior art purposes, for example, to repel water and other weathering materials, to provide a recommended minimum outdoor durability of five years, primarily comprises synthetic, acrylic-based resin. Coates inks are manufactured by Sun Chemical, a division of Dainippon Ink and Chemicals Incorporated (DIC) of Tokyo, Japan.

The resistance of a transparent coating according to one or more embodiments of the present invention to solvent attack can be measured by simple but accepted methods within the art of coatings, for example a solvent wipe test. A solvent wipe test typically requires the coating to be adapted from a water clear material to a tinted material, for example by the addition of a dyestuff, and printed on a contrasting-colored surface, for example a white surface. The transparent coating is then subjected to repetitive wipes from solvent-soaked cotton wool “buds”. For example, if one is measuring the resistance to industrial methalated spirits (IMS), the coating is normally wiped with separate IMS-soaked cotton wool buds for say 20 wipes, 40 wipes, 60 wipes, etc. The number of wipes taken to break through the coating is identified when the underlying color, say white, is visible through the tinted coating. According to one or more embodiments of the present invention, a coating suitable to resisting a wide range of ink solvents resists a minimum of 20, preferably 40 and more preferably 60 wipes of IMS-soaked cotton wool buds.

The imaging surface of an assembly is optionally the surface of the partially adhered transparent coating remote from the substrate or, in a second embodiment, the surface of an additional image receptive layer, typically applied directly to a stencil-adhering and protective layer of the partially adhered transparent coating.

In a third embodiment, the partially adhered transparent coating comprises three different layers, one to adhere the stencil to the substrate and provide some physical protection, a second layer to provide chemical protection from ink solvents or other deleterious matter and a third layer to provide a print-receptive surface.

The imaging surface will typically be receptive to one or more imaging systems for example:
(a) solvent-based inks, and/or
(b) water-based inks, and/or
(c) UV-curable inks, and/or
(d) toner, and/or
(e) thermally transferred pigmented resin.

Potential imaging systems for the design layer include screen printing, litho printing, digital inkjet printing, laser printing and thermal transfer printing, sometimes referred to as thermal mass transfer, for example of pigmented resin transferred from a carrier membrane, for example of polyester film, for example by means of heated rollers in a lamination and de-lamination machine or digitally transferred, for example in such digital printing machines as the Gerber Edge™ (a trademark of Gerber Scientific Instruments, Inc., USA).

Optionally, one or more layers of the partially adhered transparent coating are not part of a pre-formed Part Processed Material assembly but are applied by a printer prior to printing a design, for example a print-receptive coating for a particular imaging system applied to a Part Processed Material of potential use with another imaging system or of general applicability except for any required print-receptive treatment. The print-receptive treatment is optionally not a coating but, for example, a corona treatment applied by the printer before printing a design.

Typically, a plurality of superimposed layers of marking material are applied to the imaging surface. The plurality of layers of marking material comprise, for example:
(i) a plurality of layers of a single color of a single type of marking material, typically to provide an overall thickness of the marking material greater than is typically or conveniently applied in a single layer by a particular printing or coating system, or
(ii) a plurality of layers of substantially the same color but of different materials, typically to provide different functional characteristics, for example the material of a layer directly applied to the PAT coating is typically selected primarily because of its bond to the PAT coating, whereas a layer remote from the substrate, for example, might be selected for its abrasion resistance, sometimes referred to as being scratch resistant (SR), or
(iii) different uniform colors of the same type of marking material, for example to produce a simple one-way vision panel comprising a print pattern of a white or uniform color layer superimposed on a black layer, for example the white or uniform color layer to give optimum contrast to visibility of an object, for example a black squash ball or a white squash ball in a squash court having one-way vision walls, and/or for relatively high reflectivity and thereby visibility of the location of the partially printed surface and/or for the reduction of solar energy entering a vehicle or building, and the black layer is typically to enable good through-vision from the other side of the panel, or
(iv) different uniform colors of different types of marking material, for example to provide a combination of the requirements of (ii) and (iii), or
(v) a design superimposed on a print pattern comprising a background layer or layers of the same type of marking material, for example to produce a see-through graphic panel using a single print process, for example screen printing or digital inkjet printing, or
(vi) a design superimposed in one type of marking material and applied by one imaging system, for example digital solvent inkjet printing, combined with one or more background color layers applied by another type of marking material typically applied by a different imaging system, for example thermal transfer of pigmented resin or screen printing.

Optionally, the design layer is not a separate physical layer but, for example, dye colorants, which are absorbed within the partially adhered transparent coating.

Uniform layers of marking material are optionally printed or applied by another coating process, for example spraying, roller coating or by thermal transfer of layers, for example white on black pigmented resin layers by Coding, a division of Illinois Tool Works, Inc., USA.

Removal of unwanted material typically comprises an “ink fracture mechanism”, which typically resembles what is known in the art of structural engineering as a shear failure. This is typically characterized by a “fracture surface” or crack emanating from a point or line of weakness, in this case from the edge of the stencil layer through the plurality of layers of marking material. In a typical shear failure mode, the ink fracture surface is at an angle of approximately 45° to the direction of applied force. The actual mode of failure will be dependent on the nature of the marking materials, for example so-called pvc inks which have both acrylic and polyvinyl chloride constituents will be more brittle the higher the proportion of acrylic and more plastic the higher the proportion of polyvinyl chloride, the latter resulting in more strain (extension or stretching) of the material before eventual fracture. This can lead to unwanted “flaps”, “tails” or “tongues” of marking material extending beyond the desired edges of the print pattern, for example within the area or areas required to be transparent in a vision control panel.

The functional performance of the partially adhered transparent coating is therefore complicated and the selection of an appropriate material critical to the satisfactory performance of its multiple functions. The ink fracture mechanism and removal of unwanted material leaves the superimposed layers of marking material in substantially exact registration only if the stencil material, the partially adhered coating material and marking material(s) are appropriately selected and applied to the substrate. Drying or curing of ink layers is also critical to enabling a suitable ink fracture mechanism, for example solvent inks typically rely on increased rate of air flow and/or temperature and/or drying duration than in the conventional production of graphic products.

The term “exact registration” is often misused in the printing industry, and particularly in the marketing of printing machines, including being used to describe processes that inevitably suffer lack of registration owing to, at least:
(i) printing machine tolerance, and
(ii) delivery of substrate tolerance, and
(iii) “dot gain” or “dot loss” for a particular marking material on a particular substrate and, in many cases,
(iv) dimensional movement of the substrate, for example in a sequential imaging and curing cycle, for example through temperature and/or humidity variation.

In the context of one or more embodiments of the present invention, the terms “exact registration” or “substantially exact registration” mean that the alignment of edges of a plurality of superimposed layers of marking material following removal of unwanted material is typically consistent with a 45° ink fracture mechanism or mode of failure, being of the order of the overall thickness of the plurality of layers of marking material, typically less than 20 micron and commonly less than 10 micron. This lack of registration can be increased by the above-mentioned tensile strain characteristics of a particular marking material. The ink fracture mechanism or mode of failure can typically be seen with the aid of an optical microscope, for example each layer of marking material is typically visible at each edge of the print pattern, for example rings around each dot within a print pattern of dots, which may be described as having a truncated conical surface. However, such lack of registration is minute compared to the width of a typical printed portion. For example, 10 microns out of vertical alignment at the edge of a dot of say 1.0 mm diameter justifies the term of “exact registration” or “substantially exact registration” achieved by the method according to one or more embodiments of the invention, compared with a normal lack of registration in printing superimposed layers, for example of 0.1 or 0.2 mm in screen printing. There is typically no lack of registration at the interface of successive layers of marking material, as the ink fracture passes across the interface. The lack of registration of any two successively printed layers is typically a maximum of the overall thickness of those two layers.

UV-cured inks are typically not suited to enabling a clean ink fracture mechanism owing to chemical cross-linking, for example their typically substantial in-plane tensile strength preventing such fracture or leading to jagged, inconsistent fracture mechanisms, for example surface UV ink layers “breaking back” or fracturing along lines remote from the desired edges of the print pattern. However, it is possible to “sandwich” an intermediate thin UV-cured inkjet design layer between a solvent-based partially adhered transparent coating and solvent ink background color layers, which tend to induce overall fracture in the desired positions along the edges of the print pattern, including within the UV-cured inkjet layer. This is akin to the fracture of laminated glass in which the rupture of extremely pliable polyvinyl chloride film with substantial tensile strength is typically initiated and located along the line of breakage of the more brittle sheets of glass to which it is adhered.

The method can be used to make a variety of products in which the superimposition of layers of marking material with substantially exact registration is desired, on a wide variety of opaque, transparent, optically transparent, or translucent substrates. It is especially suited to making vision control panels comprising a design printed reverse-reading on one side of a transparent substrate and visible right-reading from the other side of the substrate, followed by, for example, white and black layers, to make so-called one-way vision panels according to US RE37,186, or followed by a translucent white layer to make panels according to U.S. Pat. No. 6,212,805 which can be illuminated from the one side of the transparent substrate. The Part Processed Material assembly is also particularly useful for making see-through graphic panels with one design visible from one side and another design visible from the other side of the panel, according to US RE37,186.

The method is also useful for printing discrete indicia on a transparent or non-white opaque substrate, in which it is also desired to provide a white background layer in substantially exact registration with the design color layer or layers of each indicium.

Another use for the one or more embodiments of the invention is to overcome the problem of abutting areas of different colors, normal lack of registration typically leading to either separation or visible overlap of adjacent areas. A first design color layer extends under the whole of an adjacent area of a second design color layer as well as an adjacent area. The first design color layer is typically coterminous with the non-mutual boundary or boundaries of the second color area, typically resulting in two areas of the desired colors with a “clean” mutual boundary.

Typically, it is possible to take a particular cross-section through the assembly, which cross-section includes a substrate having two outer edges, a partially adhered transparent coating having two outer edges, a stencil layer comprising a release surface, the stencil layer being the negative of and thus defining a print pattern, the stencil layer comprising a plurality of alternate “stencil layer portions” and “portions devoid of the stencil layer”, each stencil layer portion having two outer edges, the partially adhered transparent coating being firmly adhered to the substrate within said plurality of portions devoid of the stencil layer. The two outer edges of the partially adhered transparent coating advantageously are located within the two outer edges of the stencil layer, to assist the subsequent removal of unwanted marking material, the stencil layer is thereby exposed to the applied removal force of removal of an adhering layer or jetting. The cross-section optionally comprises a print-receptive layer applied to the partially adhered transparent coating, the print receptive layer having two outer edges.

Typically, it is possible to take a particular cross-section through a panel of the converted assembly comprising superimposed layers of marking material in substantially exact registration, the particular cross-section being at the same location as the particular cross-section through the assembly before conversion, which cross-section includes the substrate having two outer edges and the print pattern comprising the partially adhered transparent coating, a design layer and a background color layer, the print pattern comprising a plurality of alternate “printed portions” and “unprinted portions”, each printed portions having two outer edges. At least one of the printed portions includes a part of the partially adhered transparent coating having two outer edges, a part of the design layer having two outer edges and a part of the background color layer having two outer edges, the background color layer extending throughout the width between the two outer edges of the printed portion. At least two adjacent printed portions include a part of the “design layer” of imaging material, which typically underlies but optionally overlies the background color layer. Optionally, in the at least one of the printed portions, the two outer edges of part of the partially adhered transparent coating and the two outer edges of the part of the design layer and the two outer edges of the part of the background color layer are in substantial alignment.

While the assembly is typically used to apply a design layer reverse-reading and which is visible right-reading through the substrate, the assembly can also be used to manufacture panels according to US RE37,186 and U.S. Pat. No. 6,212,805, in which one or more background color layers are first applied to the assembly, followed by a design printed right-reading, for example to form a vision control panel to be applied to the outside of a window. One or more embodiments of the present invention provides a universal solution for the manufacture of vision control panels comprising substantially exact registration printing, with either an opaque or translucent print pattern and for external (first surface) or internal (second surface) application to a window. The type or types of marking material and the light transmissivity of each layer can be selected or created by the converter of the assembly to make the desired finished panel.

With some assembly embodiments and their intended types of subsequently applied marking material, the partially adhered transparent coating can be a material of similar composition and optionally of similar method of application as the intended imaging layers. For example, if the assembly is to be subsequently imaged by screen printing with a pvc solvent ink, the partially adhered transparent coating can be a transparent pvc solvent ink of the same type. However, if the assembly is to be imaged by, for example, digital inkjet solvent inks, with aggressive solvent contents, the partially adhered transparent coating advantageously comprises a substantially solid layer with no voids caused by the evaporation of solvents, for example a thin layer of UV-cured ink or epoxy ink, which turns into a substantially solid layer to act as an effective barrier to the passage of such aggressive solvents to the stencil layer and substrate.

Additional and/or alternative objects, features, aspects, and advantages of the present invention will become apparent from the following description, the accompanying drawings, and the appended claims.

### BRIEF DESCRIPTION OF THE DRAWINGS

For a better understanding of embodiments of the present invention as well as other objects and further features thereof, reference is made to the following description which is to be used in conjunction with the accompanying drawings, where:

FIGS. 1A-6J are diagrammatic cross-sections of stages in the manufacture and conversion of assemblies according to various embodiments of the present invention.

FIGS. 7 and 8 are diagrammatic cross-sections through methods of removing unwanted marking material according to various embodiments of the present invention.

FIGS. 9A and B are diagrammatic cross-sections through an ink fracture mechanism according to various embodiments of the present invention.

FIGS. 10A-13B are elevations of finished vision control panels according to various embodiments of the present invention.

### DETAILED DESCRIPTION OF PREFERRED EMBODIMENTS OF THE INVENTION

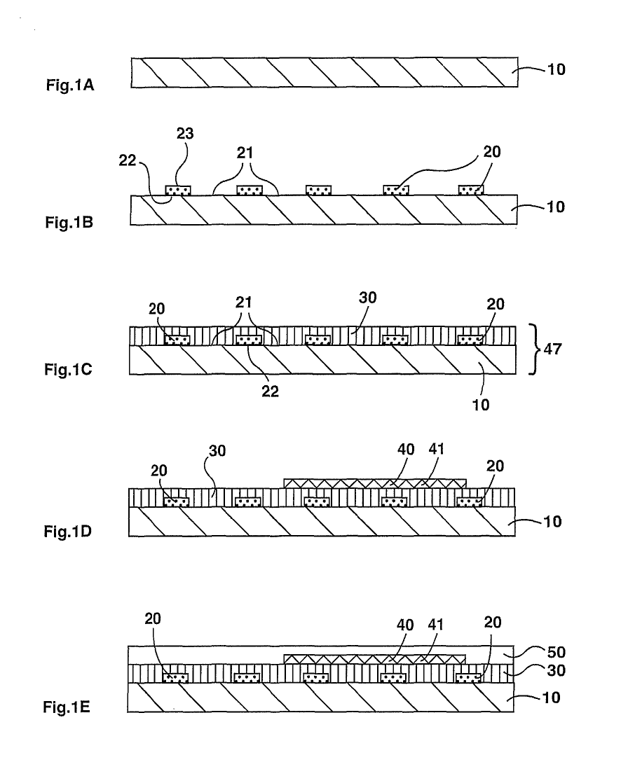

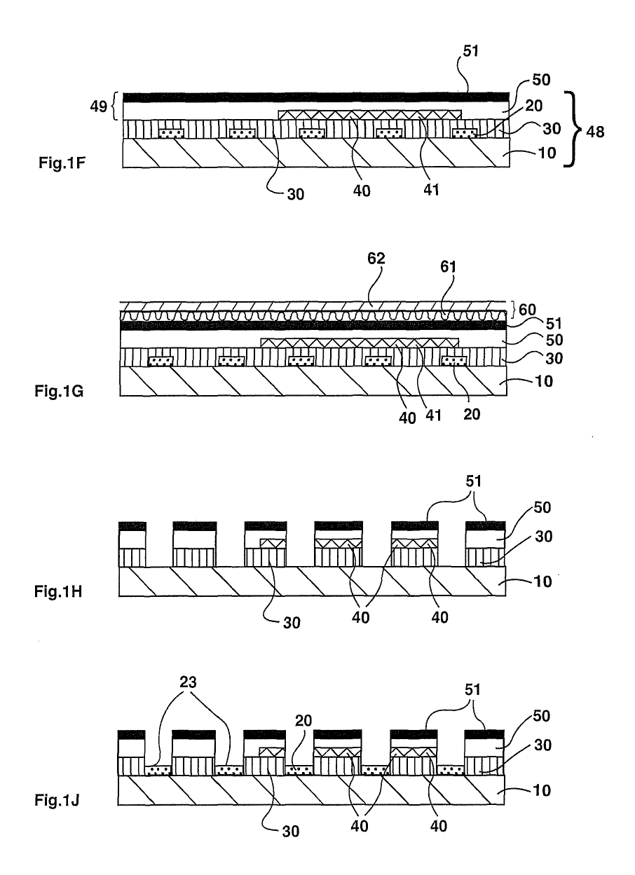

FIGS. 1A-J are diagrammatic cross-sections through the manufacture of an assembly, shown in FIG. 1C, and its subsequent conversion to form a one-way vision control panel, in FIGS. 1D-J. FIG. 1A illustrates substrate 10 and FIG. 1B shows stencil layer 20 comprising release surface 22 adjacent to the substrate and/or release surface 23 remote from the substrate. Stencil layer 20 defines a print pattern 21 which is devoid of the stencil layer. In FIG. 1C, partially adhered transparent coating 30 is applied to both the substrate throughout the print pattern 21 and the stencil layer 20, in one continuous coating or a plurality of coatings, to form an assembly according to one or more embodiments of the invention, typically a Part Processed Material to be converted to form a finished panel with a plurality of layers of marking material in substantially exact registration. Partially adhered transparent coating 30 is typically transparent. In FIG. 1D, design layer 40 comprises design color layer 41 of a single or “spot” color, the design printed reverse-reading, to be visible right-reading through partially adhered transparent coating 30 and substrate 10. FIG. 1E shows background color layer 50, for example a layer of white ink to act as a background to design 40. Another background color layer 51, for example a layer of black ink, is applied to background color layer 50 in FIG. 1F. In FIG. 1F, superimposed layers of marking material 49 comprise design layer 40, background color layer 50 and another background color layer 51. In order to produce the finished panel, unwanted layers of marking material outside the print pattern are removed, typically by the application of a force at the exposed surface of the background color layer or layers remote from the substrate, for example by the application and removal of an adhering layer, for example a layer of plastisol ink or a self-adhesive film 60, comprising a filmic layer 62, for example of plastic or paper and pressure-sensitive adhesive 61, as illustrated in FIG. 1G. Upon removal of the adhering layer, the unwanted ink is removed, either with the stencil layer as illustrated in FIG. 1H if the stencil release layer is adjacent to substrate 10, or retaining the stencil layer 20 on the substrate, if the stencil release layer 23 is remote from the substrate, as illustrated in FIG. 1J. Alternatively, the unwanted ink may be removed by abrasion, for example by high-pressure water jetting, with or without an abrading medium, or air jetting with or without an abrading medium. In the case of a one-way vision panel, the stencil layer 20 in FIG. 1J should be transparent, in order to allow through vision from the printed side of substrate 10, while design 40 is visible through substrate 10 and partially adhered transparent coating 30. Example materials for use with the embodiment of FIGS. 1A-J include a plastic substrate, for example clear, transparent acrylic, pvc, polycarbonate or print-treated polyester, for example print-treated with a coating or co-extruded layer to be receptive to the adhesion of partially adhered transparent coating 30. Stencil 20 can be of any material which can be accurately printed to define the print pattern and which does not adhere well to substrate 10 and/or subsequently applied layers of marking material, for example an organic solvent-based printing ink with low adhesion to the particular substrate or the subsequently applied layers of marking material which comprise, for example, a conventional pvc solvent-based ink with good adhesion to the particular substrate and each successive layer, for example Coates Vynaglaze. In this embodiment, the partially adhered transparent coating can be the clear ink within the Coates Vynaglaze range of inks, sometimes referred to as a varnish ink, which adheres well to the substrate referred to above and the superimposed layers of marking material, having compatible ink resin and solvents. Typically, the Part Processed Material assembly of FIG. 1C is sufficiently durable to be cut, packaged and shipped to printers, whether in sheet or roll form, to be handled by the printer and managed through an imaging system, typically a printing machine, without damaging the stencil layer 20.

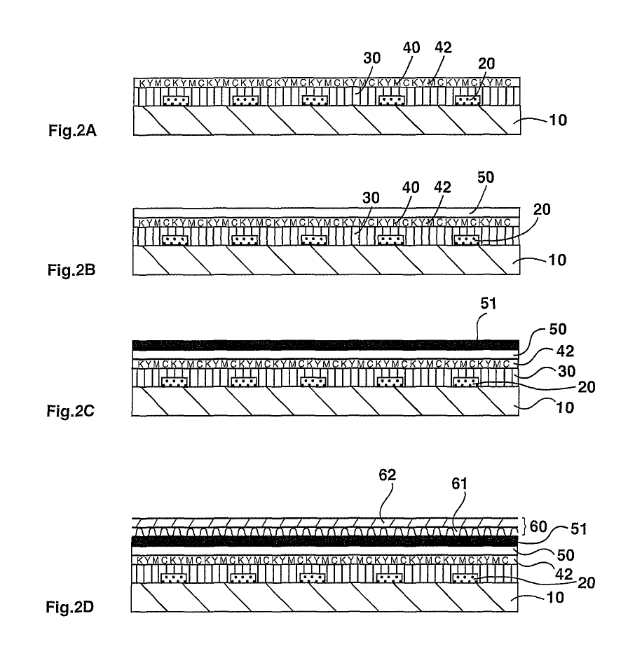

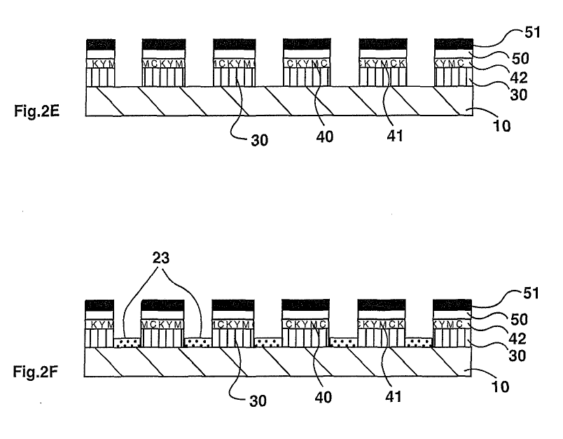

FIGS. 2A-F are similar to FIGS. 1D-J, except that the Part Processed Material of FIG. 1C is printed with a design layer 40 comprising a layer of four color process inks 42, for example typically applied in the order of process black (K), yellow (Y) magenta (M), and cyan (C), the design being printed reverse-reading but to be visible right-reading through partially adhered transparent coating 30 and substrate 10. Suitable four color process inks include, for example, Coates Vynaglaze cyan, magenta, yellow and process black for screen printing or solvent inkjet inks supplied, for example, by HP Scitex, a division of Hewlett Packard, US.

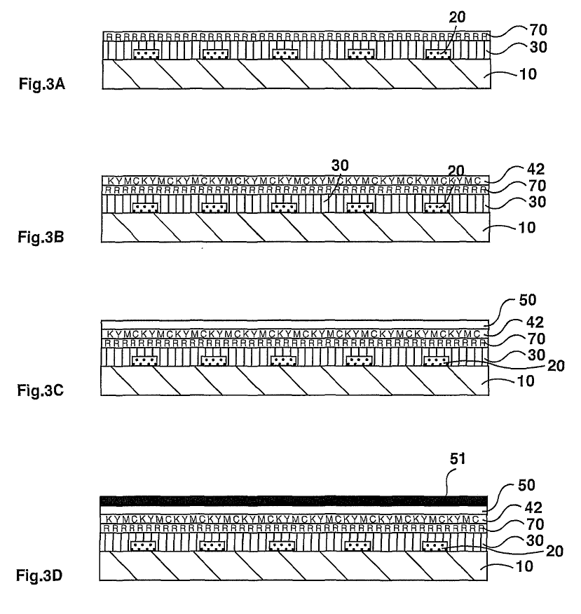

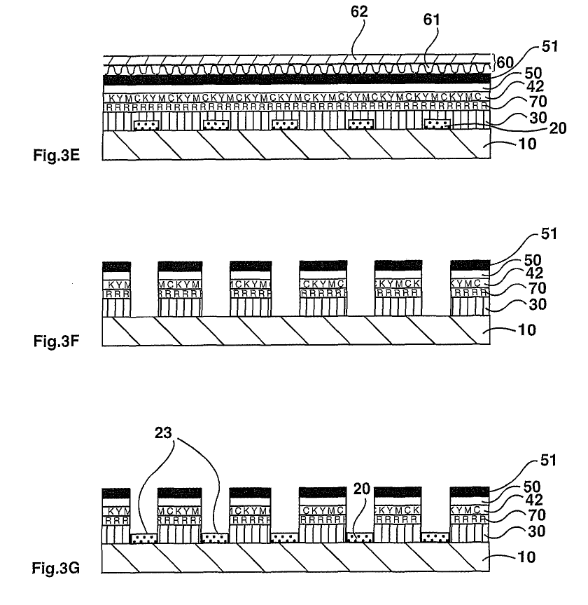

FIGS. 3A-G illustrate the second embodiment of the invention in which the assembly of FIG. 3A is similar to the assembly of FIG. 2C but with an additional print-receptive layer 70, for example a coating receptive to water-based inkjet inks known in the art, for example silicate-based or polymeric pvp or pva (“swellable”) ink-receptive layers. The print-receptive layer is advantageously applied to a solvent-resistant layer, for example a polyurethane varnish. The four color process inks 42 of design 40 in FIG. 3B, for example water-based inks supplied by Hewlett Packard, adhere well to the print-receptive layer 70. FIGS. 3C-G illustrate similar production stages to FIGS. 2B-F. A print-receptive layer of Coates Vynalam transparent medium 269506 is receptive to most imaging systems designed to print on PVC film, for example, solvent inkjet.

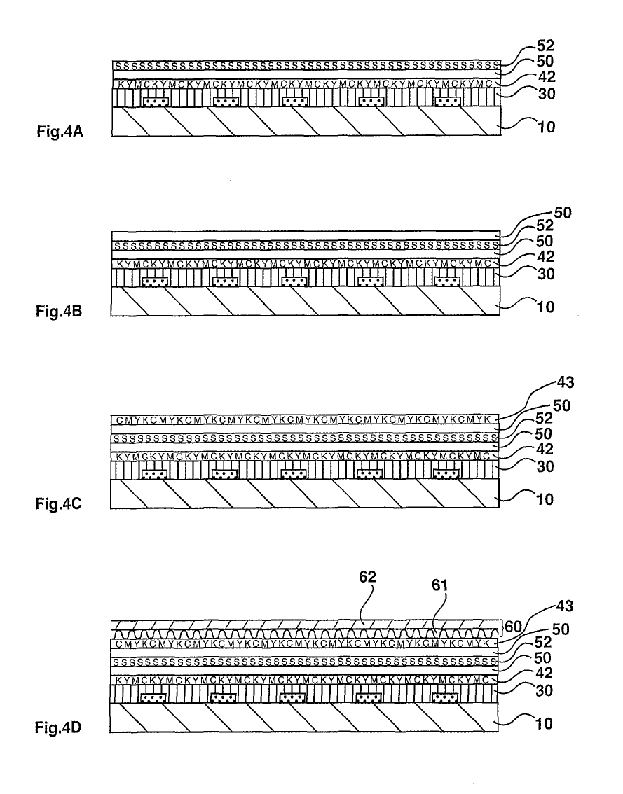

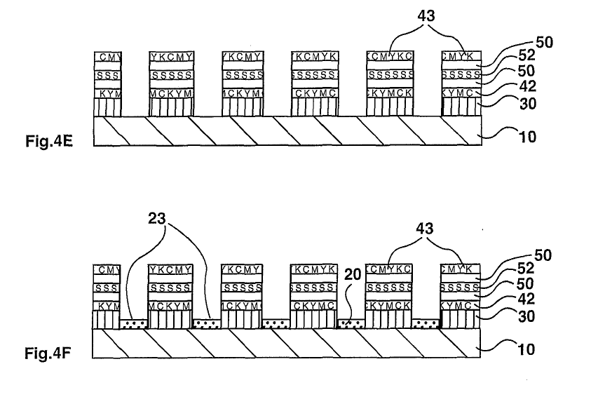

FIGS. 4A-F illustrate the production of a see-through graphic panel according to US RE37,186 comprising reverse-printed design layer 42 visible through partially adhered transparent coating 30 and substrate 10, and right-reading design layer 43, for example a four color process layer printed in the order CMYK and visible from the printed side of substrate 10. The intermediate layers between design layers 42 and 43 typically comprise a plurality of white background color layers 50 and, optionally, a layer 52 intermediate two white background color layers 50, for example a silver, gray, black or a partially printed black layer, for example a 50% coverage of process black ink.

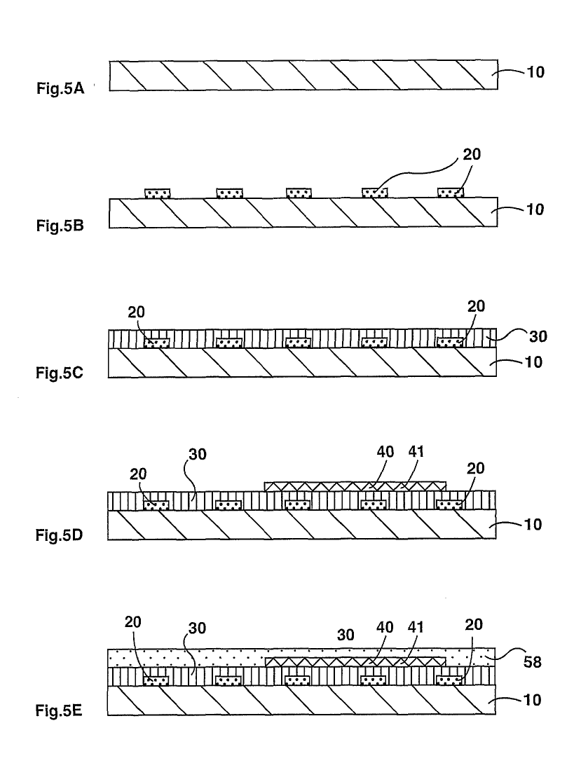

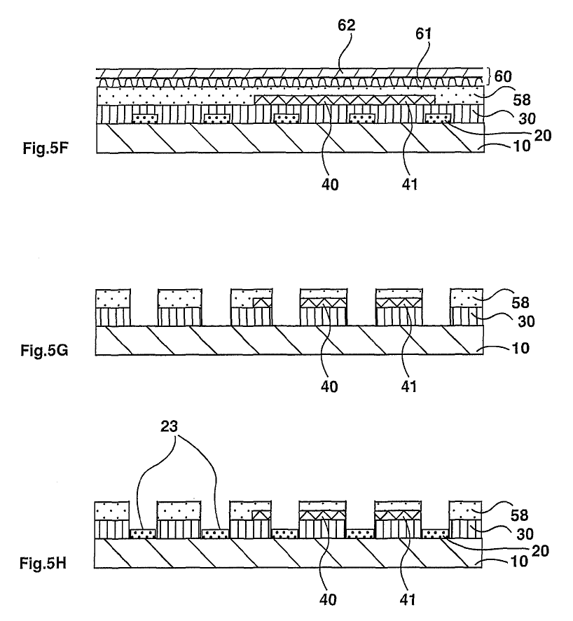

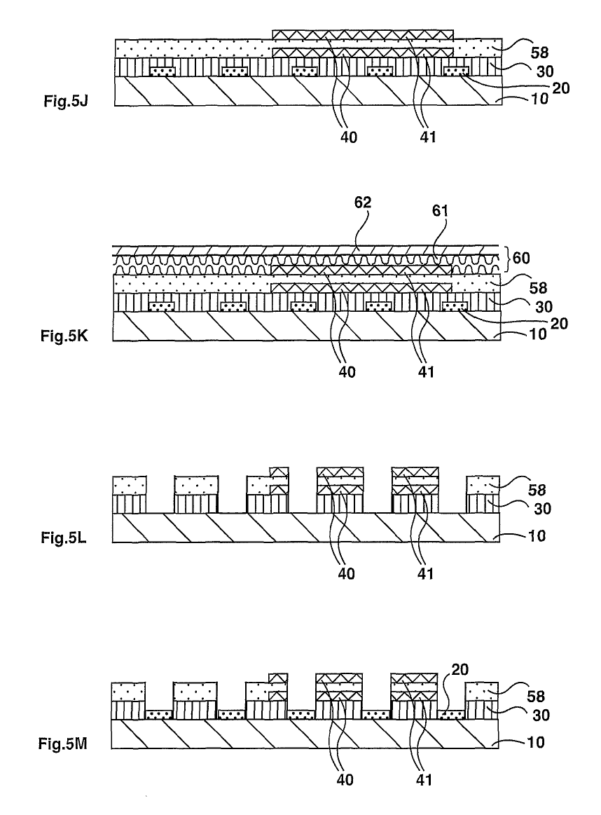

FIGS. 5A-H illustrate diagrammatic cross-sections in the stages of production of a see-through graphic panel according to U.S. Pat. No. 6,212,805 comprising a translucent design layer 41 in FIG. 5D, and translucent background color layer 58, typically white, in FIG. 5E. The finished panel of FIG. 5G with the stencil removed or of FIG. 5H with the stencil retained can be illuminated from the printed side of substrate 10 and the design will be clearly visible during the hours of darkness from the other side of substrate 10. FIGS. 5J-M illustrate the production of a see-through graphic panel according to U.S. Pat. No. 6,212,805 comprising two design layers 40 both facing in the same direction, either both printed reverse-reading or both printed right-reading, disposed on either side of intermediate translucent background color layer 58, typically white. FIG. 5L is the finished panel if the stencil 20 is removed and FIG. 5M is the finished panel if the stencil 20 is retained.

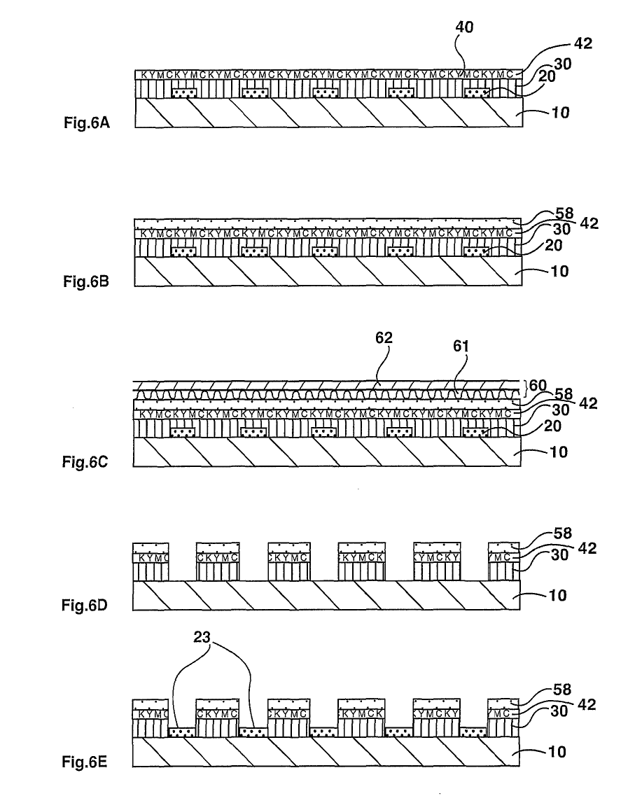

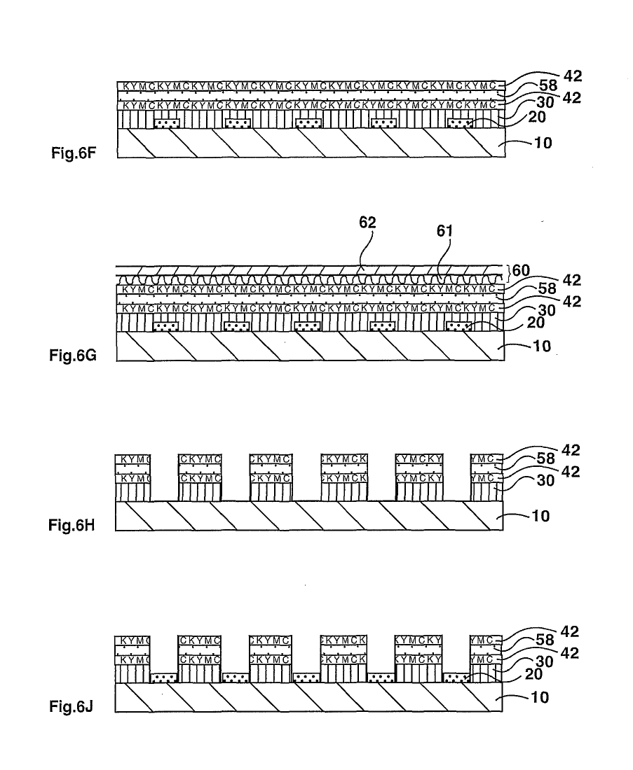

FIGS. 6A-E are similar to FIGS. 5D-H and FIGS. 6F-J are similar to FIGS. 5J-M, except that design layer 40 comprises four color process design layer 42 printed reverse-reading, typically in the order of KYMC.

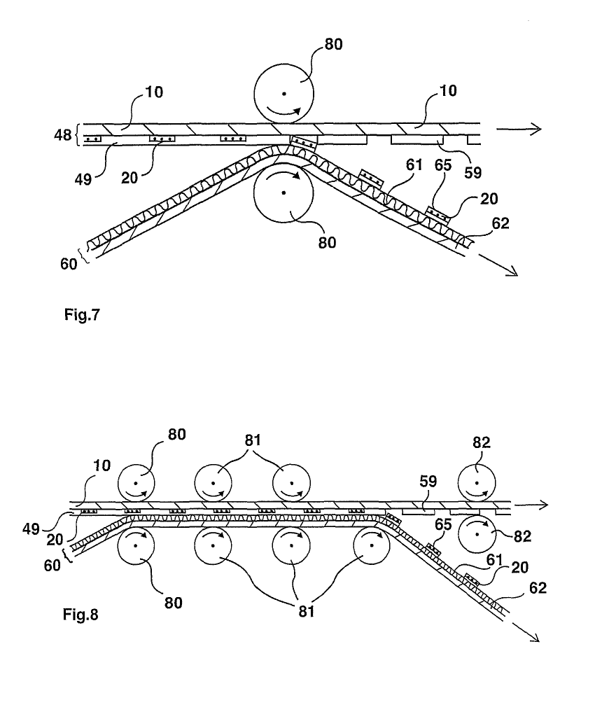

FIG. 7 is a cross-section through part of a machine for the automatic lamination and delamination of self-adhesive material 60 to imaged assembly 48 comprising the superimposed layers 49 of partially adhered transparent coating and marking material, stencil layer 20 and substrate 10 by means of nip rollers 80, which are optionally heated. When the self-adhesive material is pulled away from the imaged assembly, unwanted superimposed layers 49 and stencil layer 20 are selectively removed in unwanted material portions 65 to a wind-up spool (not shown) for subsequent disposal, leaving the desired superimposed layers in the desired printed portions 59 of the print pattern in substantially exact registration.

FIG. 8 is similar to FIG. 7 except that supplementary nip rollers 81 enhance the bond between the self-adhesive assembly 60 and the imaged assembly 48 prior to delamination, feeding of the finished panel being assisted by feed rollers 82.

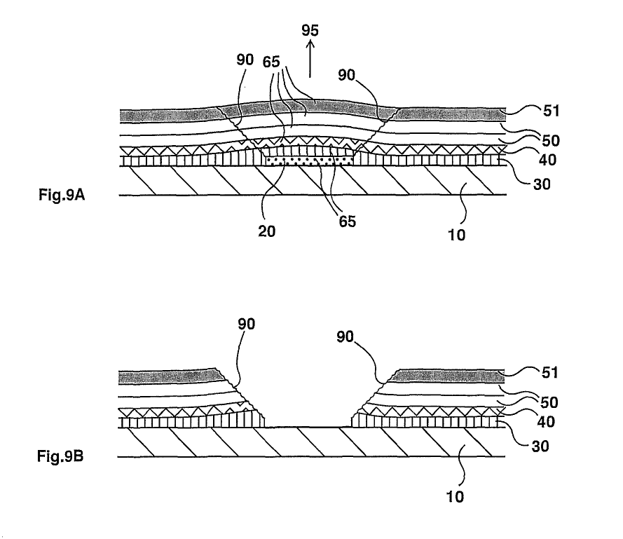

FIG. 9A is a diagrammatic cross-section through a portion of stencil layer 20 on substrate 10 with superimposed, partially adhered transparent coating 30, design layer 40, background color layer 50, for example of white ink, and another background layer 51, for example of black ink, subjected to ink removal force 95, for example by means of the lamination and de-lamination of a self-adhesive film (not shown), causing ink fracture mechanism 90, resulting in the removal of unwanted material portion 65, for example as illustrated in FIG. 9B.

FIGS. 10A and 10B illustrate elevations of the panel of FIG. 1H. In FIG. 10A design 40 “ABCD” is visible through optically transparent substrate 10 and transparent coating 30 against a white background color layer 50 in a print pattern of lines. FIG. 10B illustrates the other, printed side of the panel, black lines 51 permitting good visibility through the optically transparent substrate 10 in between black lines 51.

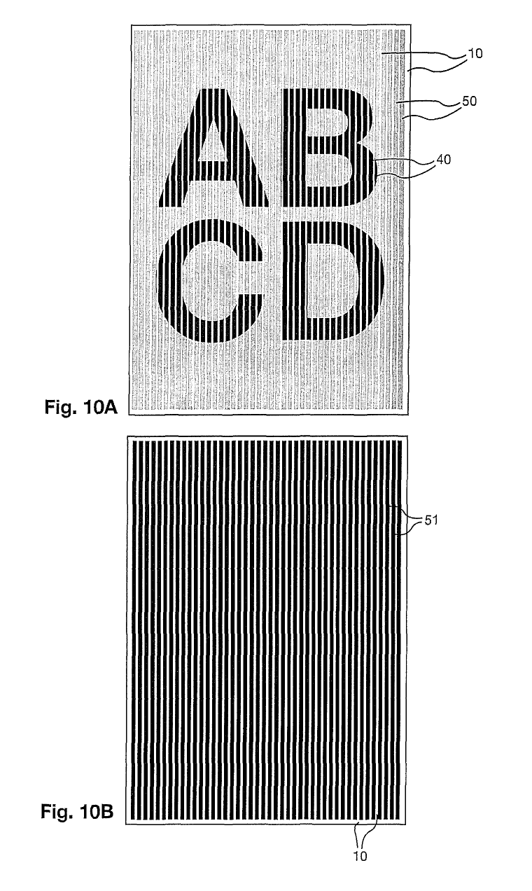

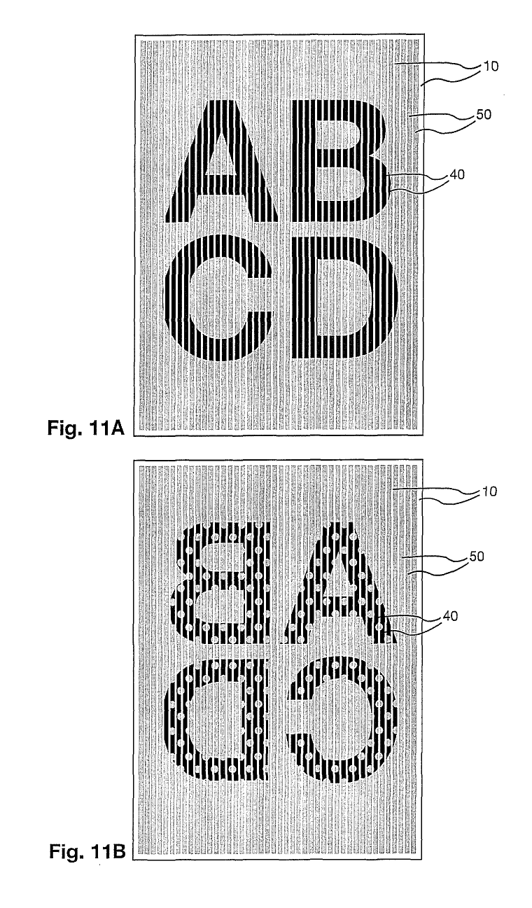

FIGS. 11A and 11B illustrate elevations of the panel of FIG. 5G. In FIG. 11A design 40 “ABCD” is visible through optically transparent substrate 10 and transparent coating 30 against a white background color layer 50 in a print pattern of lines. FIG. 11B illustrates the other, printed side of the panel, the reverse image of design 40 being visible through translucent white lines 50, permitting some visibility through the optically transparent substrate 10 and transparent coating 30 in between white lines 50.

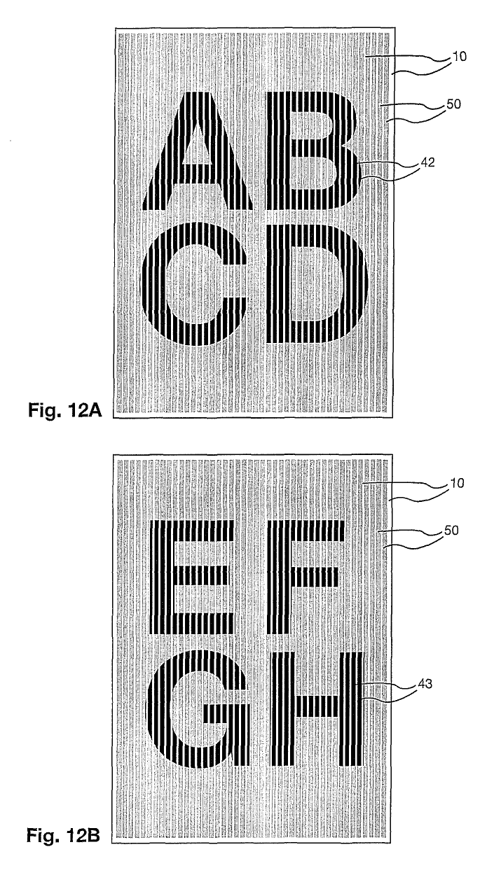

FIGS. 12A and 12B illustrate elevations of the panel of FIG. 4E. In FIG. 12A, a four color process design 42 “ABCD” is visible through optically transparent substrate 10 and transparent coating 30 against a white background color layer 50 in a print pattern of lines. FIG. 12B illustrates the other, printed side of the panel, another four color process design 43 being visible against a white background color layer 50 in the print pattern of lines, permitting some visibility through the optically transparent substrate 10 in between white lines 50.

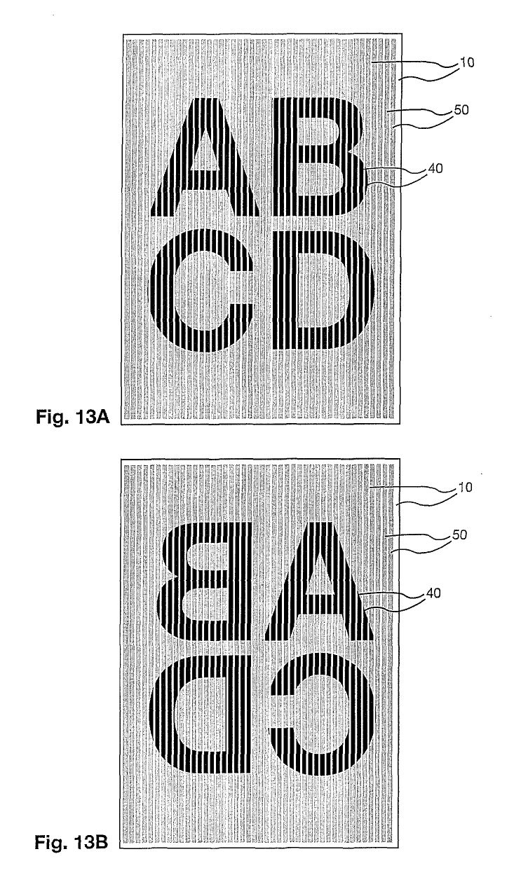

FIGS. 13A and 13B illustrate elevations of the panel of FIG. 5L. In FIG. 12A, design 40 “ABCD” is visible through optically transparent substrate 10 and transparent coating 30 against a white background color layer 50 in a print pattern of lines. FIG. 13B illustrates the other, printed side of the panel, the reverse of design 40 being visible against the white background color layer 50 in the print pattern of lines, permitting good visibility through the optically transparent substrate 10 in between white lines 50.

One or more embodiments of the invention are capable of being practiced by a wide range of partially adhered transparent coating materials and imaging systems, providing these are compatible, including the requirement that all layers of the partially adhered transparent coating and subsequently applied marking materials or colorants must adhere to each adjacent layer. The partially adhered transparent coating optionally comprises proprietary materials formulated and used for other purposes or only a single one purpose of the multiple purposes of the partially adhered transparent coating. For example, “Lyson Printbond” supplied by Nazdar, Inc., US, adheres well to a wide variety of substrates and provides an excellent print-receptive surface for virtually all solvent and UV imaging systems. However, it also provides the ability to hold down the stencil layer and, as a halogenated polyolethene, is hard to dissolve and thus provides a protection to the stencil layer and substrate from ink solvents.

As another example, of the second embodiment, a printer can apply “Lyson Pre-Post” coating, made by Nazdar, Inc., USA, within approximately one hour of printing, when it will absorb water-based inks but then becomes water-resistant, a common requirement of vision control panels made by one or more embodiments of the present invention.

The foregoing illustrated embodiments are provided to illustrate the structural and functional principles of the present invention and are not intended to be limiting. To the contrary, the principles of the present invention are intended to encompass any and all changes, alterations and/or substitutions within the spirit and scope of the following claims.

What is claimed is:

1. An assembly comprising:
a substantially imperforate substrate;
a transparent coating; and
a stencil layer that includes a release surface disposed between the substrate and the coating,
wherein a cross-section through said assembly comprises said substrate having two outer edges, said coating having two outer edges and a plurality of alternate stencil layer portions and portions devoid of the stencil layer, each stencil layer portion having two outer edges, said coating being located on the surface of said stencil layer remote from said substrate and being firmly adhered to said substrate within each of said plurality of portions devoid of said stencil layer.

2. The assembly of claim 1, wherein the substrate is transparent.

3. The assembly of claim 2, further comprising a design layer printed reverse-reading onto the assembly on a side of the coating remote from the substrate, the design layer being right-reading visible through the substrate.

4. The assembly of claim 1, wherein the assembly is rolled into a roll.

5. The assembly of claim 1, wherein the assembly comprises a cut sheet.

6. The assembly of claim 1, wherein the coating is continuous and bridges each boundary between the stencil layer and the substrate disposed within said plurality of portions devoid of said stencil layer.

7. The assembly of claim 1, wherein the release surface is disposed on a substrate side of the stencil layer.

8. The assembly of claim 1, wherein the release surface is disposed on a coating side of the stencil layer.

9. The assembly of claim 1, wherein the coating comprises two layers, a first layer of which adheres the stencil layer to the substrate, a second layer of which provides a print-receptive surface, the second layer being disposed on a side of the first layer remote from the substrate, the first and second layers comprising different materials.

10. The assembly of claim 9, wherein the coating further comprises a third layer that is substantially impervious to solvent-based inks, the third layer being disposed on the side of the first layer remote from the substrate, the third layer comprising a material that is different than the first and second layers of the coating.

11. The assembly of claim 1, wherein the stencil is transparent.

12. The assembly of claim 1, wherein the stencil is optically transparent.

13. The assembly of claim 11, wherein the stencil is water clear.

14. A method of making a design on an assembly, the assembly comprising
a substantially imperforate substrate;
a transparent coating; and
a stencil layer that includes a release surface disposed between the substrate and the coating,
wherein a cross-section through said assembly comprises said substrate having two outer edges, said coating having two outer edges and a plurality of alternate stencil layer portions and portions devoid of the stencil layer, each stencil layer portion having two outer edges, said coating being located on the surface of said stencil layer remote from said substrate and being firmly adhered to said substrate within each of said plurality of portions devoid of said stencil layer,
the method comprising:
printing a plurality of layers of marking material onto the assembly on a side of the coating remote from the substrate, the plurality of layers comprising a design layer and a background color layer, the design layer being applied reverse-reading, the design layer being right-reading visible through the substrate.

15. The method of claim 14, further comprising, prior to printing the plurality of layers of marking material onto the assembly, transporting the assembly from a first geographic location to second geographic location disposed at least a mile away from the first geographic location.

16. The method of claim 15, further comprising:
prior to transporting the assembly from the first geographic location to the second geographic location, rolling the assembly into a roll; and
before printing the plurality of layers of marking material onto the assembly, unrolling the rolled assembly.

17. The method of claim 14, wherein the assembly is rolled into a roll, and wherein the method further comprises unrolling the assembly prior to printing the plurality of layers of marking material onto the assembly.

18. The method of claim 14, further comprising:
applying a force to said plurality of layers of marking material, said force substantially removing said coating and said plurality of layers of marking material disposed on said stencil layer, leaving said coating and said plurality of layers of marking material adhered to said substrate in substantially exact registration within the edges of said plurality of portions devoid of said stencil layer.

19. The method of claim 14, wherein the plurality of layers of marking material comprise marking materials that would penetrate the stencil layer if printed directly onto the stencil layer.

20. A method of making a design on an assembly,
the assembly comprising
a substantially imperforate substrate;
a transparent coating; and
a stencil layer that includes a release surface disposed between the substrate and the coating,
wherein a cross-section through said assembly comprises said substrate having two outer edges, said coating having two outer edges and a plurality of alternate stencil layer portions and portions devoid of the stencil layer, each stencil layer portion having two outer edges, said coating being located on the surface of said stencil layer remote from said substrate and being firmly adhered to said substrate within each of said plurality of portions devoid of said stencil layer,
the method comprising:
printing a plurality of layers of marking material onto the assembly on a side of the coating remote from the substrate, the plurality of layers comprising a design layer and a background color layer, the design layer being disposed between the background color layer and the substrate, the design layer being visible through the substrate.
